(19) United States
(12) Patent Application Publication
(10) Pub. No.: US 2017/0368683 A1
(43) Pub. Date: Dec. 28, 2017

(54) USER PORTRAIT BASED SKILL PACKAGE RECOMMENDATION DEVICE AND METHOD

(71) Applicant: SHENZHEN GOWILD ROBOTICS CO., LTD., Shenzhen (CN)

(72) Inventors: Nan QIU, SHENZHEN (CN); Haofen WANG, SHENZHEN (CN)

(21) Appl. No.: 15/694,913

(22) Filed: Sep. 4, 2017

Related U.S. Application Data
(63) Continuation-in-part of application No. PCT/CN2016/087530, filed on Jun. 28, 2016.

(51) Int. Cl. B25J 9/16; G06N 99/00; G05B 19/042; G06F 9/445; G06K 9/00; G06F 3/0482; H04L 29/08; H04L 29/06

(52) U.S. Cl. CPC B25J 9/1656; G05B 19/0426; G06N 99/005; G06F 8/61; G06F 8/65; G05B 2219/25323; G06F 3/0482; H04L 67/12; H04L 67/34; H04L 67/42; G06K 9/00221

(57) ABSTRACT

The present invention discloses a user portrait based skill package recommendation device, comprising: an acquisition module, used for acquiring and collating the identity information of an intelligent robot user and the interaction information of the user and an intelligent robot, and acquiring the user portrait information of the user; an analysis module, connected to a skill package management platform at a cloud network terminal, and used for analyzing the user portrait information and associating a first skill package on the skill package management platform according to the user portrait information; and a recommendation module, used for acquiring the description information of each first skill package, and pushing the description information to the intelligent robot user.

### RELATED APPLICATIONS

This is a continuation-in-part application of International Application PCT/CN2016/087530, with an international filing date of Jun. 28, 2016, which is incorporated herein by reference in its entirety.

### FIELD OF THE INVENTION

The present invention relates to the field of system management, in particular to a user portrait based skill package recommendation device and method.

### BACKGROUND OF THE INVENTION

With the gradual development of intelligent robot and Internet, the performances of the intelligent robot are constantly improved, and in the Internet industry, a variety of skill packages are launched constantly to enrich the capabilities of the intelligent robot, wherein each skill package represents a capability of the intelligent robot. By installing skill packages, the intelligent robot completes a capability learning process, and thus has various functions to bring fun to the life of a user.

However, the learning process of the intelligent robot requires the participation of user at any time. Namely, each skill package installed on the intelligent robot is required to be browsed and filtered by the user on a skill package management platform before being installed on the intelligent robot. The user wastes a lot of time in the filtering process. For a user busy in work and having little spare time, the intelligent robot thereof learns few capabilities, thus bringing a poor use experience to the user.

### OBJECTS AND SUMMARY OF THE INVENTION

The present invention solves the main technical problem of providing a single skill package upgrade management device and method, and can recommend to a user a popular skill package that the user may feel interested according to the user portrait of the user, thus saving the time of the user for browsing and selecting a skill package, and improving the use experience of the user.

To solve the technical problem mentioned above, the technical solution adopted by the present invention is: providing a user portrait based skill package recommendation device, used for recommending an installation skill package to an intelligent robot, the device comprising: an acquisition module, used for acquiring and collating the identity information of an intelligent robot user and the interaction information of the user and the intelligent robot, and acquiring the user portrait information of the user, wherein the user portrait information at least comprises the identity information of the user, the interaction information of the user and the intelligent robot, and the information pertaining to usage parameters of the user for each skill package of the intelligent robot; and the usage parameters at least comprise the usage frequency, duration and period of the user for each skill package; an analysis module, connected to a skill package management platform at a cloud network terminal, and used for analyzing the user portrait information and associating with a first skill package on the skill package management platform according to the user portrait information, wherein the description information of the first skill package comprises the whole or a part of the user portrait information; and a recommendation module, used for acquiring the description information of the first skill package, and pushing the description information to the intelligent robot user, wherein the description information of the first skill package further comprises the identity type of a dominant user of a corresponding skill package, function information and installed internal memory information.

Wherein the acquisition module comprises: an identity information acquisition unit, used for connecting an intelligent robot website to acquire the registration information of the user as the identity information of the intelligent robot user; and an interaction information acquisition unit, used for acquiring and identifying the interaction information of the user and the intelligent robot.

Wherein the analysis module comprises: an identity information analysis unit, used for analyzing the identity information of the user, determining the identity type of the user, and associating with the first skill package comprising the identity type of a dominant user in the description information; and an interaction information analysis unit, used for analyzing the interaction information of the user and the intelligent robot, identifying and filtering a high frequency word used in the interaction information, and associating with the first skill package comprising the high frequency word in the function information.

Wherein further comprising an upgrade reminding module, used for reminding to upgrade the first skill package after the recommendation module recommends the first skill package and completes installation on the intelligent robot and when an upgraded version of the first skill package is found.

Wherein the upgrade reminding module determines the high frequency usage time of the first installation package having been installed on the intelligent robot according to the usage parameter information in the user portrait information, and transmits a reminding signal to the user in the high frequency usage time.

Wherein the mode for the upgrade reminding module to remind to upgrade comprises: a voice reminder, a mobile terminal reminder and a community webpage reminder, wherein the voice reminder means that the upgrade reminding module transmits upgrade reminding information to the intelligent robot to enable the intelligent robot to remind in a voice broadcasting manner; the skill package management platform reminder means that the upgrade reminding module transmits the upgrade reminding information to an intelligent terminal connected to the intelligent robot to remind in a texting or message pushing manner; and the community webpage reminder means that the upgrade reminding module transmits the upgrade reminding information in an intra-site message manner to a skill package community website registered by the user to remind.

Wherein when the upgrade reminding module reminds to upgrade the skill package, the upgrade reminding module generates and transmits a first reminding instruction, a second reminding instruction and a third reminding instruction to the user for the user to select upgrade time.

Wherein when the user selects the first reminding instruction, the upgrade reminding module transmits the first reminding instruction to the skill package management platform, acquires the upgrade installation package of the to-be-upgraded first skill package, and transmits the upgrade installation package to the intelligent robot to perform upgrade; when the user selects the second reminding instruction, the upgrade reminding module determines the low frequency usage time of the to-be-upgraded first skill package according to the usage parameter information contained in the user portrait information, acquires the upgrade installation package of the to-be-upgraded first skill package in the low frequency usage time, and transmits the upgrade installation package to the intelligent robot to perform upgrade; and when the user selects the third reminding instruction, the upgrade reminding module aborts to remind the user to upgrade the to-be-upgraded skill package.

Wherein when the user selects the third reminding instruction, the upgrade reminding module generates a first abort reminding instruction and a second abort reminding instruction for the user to select the mode of aborting to upgrade the first skill package.

Wherein when the user selects the first abort reminding instruction, the user aborts to upgrade the to-be-upgraded first skill package to the current upgraded version; and when the user selects the second abort reminding instruction, the user aborts to upgrade the to-be-upgraded first skill package to the current upgraded version and the new version generated subsequently.

To solve the technical problem mentioned above, the technical solution adopted by the present invention is: providing a user portrait based skill package recommendation method, used for recommending an installation skill package to an intelligent robot, the method comprising the steps of: acquiring and collating the identity information of an intelligent robot user and the interaction information of the user and the intelligent robot, and acquiring the user portrait information of the user, wherein the user portrait information at least comprises the identity information of the user, the interaction information of the user and the intelligent robot, and the information pertaining to usage parameters of the user for each skill package of the intelligent robot; and the usage parameters at least comprise the usage frequency, duration and period of the user for each skill package; analyzing the user portrait information and associating with a first skill package on the skill package management platform according to the user portrait information, wherein the description information of the first skill package comprises the whole or a part of the user portrait information; and acquiring the description information of the first skill package, and pushing the description information to the intelligent robot user, wherein the description information of the first skill package further comprises the identity type of a dominant user of a corresponding skill package, function information and installed internal memory information.

Wherein the step of acquiring the user portrait information comprises: connecting an intelligent robot website to acquire the registration information of the user as the identity information of the intelligent robot user; and acquiring and identifying the interaction information of the user and the intelligent robot.

Wherein the step of analyzing the user portrait information comprises: analyzing the identity information of the user, determining the identity type of the user, and associating with the first skill package comprising the identity type of a dominant user in the description information; and analyzing the interaction information of the user and the intelligent robot, identifying and filtering a high frequency word used in the interaction information, and associating with the first skill package comprising the high frequency word in the function information.

Wherein further comprising the step of: reminding to upgrade the first skill package after the recommendation module recommends the first skill package and completes installation on the intelligent robot and when an upgraded version of the first skill package is found.

Wherein determining the high frequency usage time of a first installation package having been installed on the intelligent robot according to the usage parameter information in the user portrait information, and transmitting a reminding signal to the user in the high frequency usage time.

The present invention provides a user portrait based skill package recommendation system, comprising an application server, a skill package management platform, and a user device terminal;

The application server comprises a network interface, a communication transceiver, a first information acquirer, an information analyzer, a skill package recommender, and a second information acquirer, wherein the network interface is connected to the communication transceiver; the first information acquirer, the information analyzer, the skill package recommender, the second information acquirer, and the communication transceiver are all connected together via a bus; the application server accesses a network via the network interface, and interacts data with other devices in the network via the communication transceiver;

The first information acquirer generates, according to a communication protocol between an intelligent robot and an intelligent robot website, an information invoke request for invoking user portrait information, transmits the information invoke request to the intelligent robot and the intelligent robot website via the communication transceiver, and inputs into the information analyzer the user portrait information returned by the intelligent robot and the intelligent robot website;

The information analyzer is used for analyzing the user portrait information, and transmitting the analysis result to the second information acquirer;

The second information acquirer is used for generating a search request via the search interface of the skill package management platform according to the analysis result of the portrait information, and transmitting the search request to the skill package management platform via the communication transceiver.

The skill package management platform associates with a first skill package on the skill package management platform according to the user portrait information in the search request, and feeds back all the associated first skill packages to the second information acquirer, wherein the description information of the first skill package comprises the whole or a part of the user portrait information; and

[symbol]

The skill package recommender is used for acquiring the description information of the first skill package from the second information acquirer, and pushing the description information to the user device terminal, wherein the description information of the first skill package further comprises the identity type of a dominant user of a corresponding skill package, function information and installed internal memory information.

Preferably, the first information acquirer is specifically used for:

Connecting an intelligent robot website to acquire the registration information of the user as the identity information of the intelligent robot user; and

Acquiring and identifying the interaction information of the user and the intelligent robot.

Preferably, the information analyzer is specifically used for:

Analyzing the identity information of the user, and determining the identity type of the user; and

Analyzing the interaction information of the user and the intelligent robot, identifying and filtering a high frequency word used in the interaction information;

The skill package management platform is specifically used for:

Associating with the first skill package on the skill package management platform according to the identity type of the user in the search request and the high frequency word used in the communication information, and feeding back all the associated first skill packages to the second information acquirer.

Preferably, further comprising an upgrade reminding processor, used for: transmitting a message for reminding the user to upgrade the first skill package to the user device terminal after the first skill package is recommended and installed on the intelligent robot and when an upgraded version of the first skill package is found.

Preferably, the upgrade reminding processor is further used for determining the high frequency usage time of the first installation package having been installed on the intelligent robot according to the usage parameter information in the user portrait information, and transmitting a reminding signal to the user in the high frequency usage time.

Different from the prior art, the user portrait based skill package recommendation device of the present invention determines the identity type of a user by acquiring and analyzing user portrait information, selects a high frequency word used in the interaction information of the user and an intelligent robot, selects from a skill package management platform a skill package having the same user identity type and a skill package the functional tag of which comprises the high frequency word, and recommends the selected skill packages to the user. The present invention can recommend to a user a popular skill package that the user may feel interested according to the user portrait of the user, thus saving the time of the user for browsing and selecting a skill package, and improving the use experience of the user.

### BRIEF DESCRIPTION OF FIGURES

FIG. 1 is a structural schematic diagram of the user portrait based skill package recommendation device according to an embodiment of the present invention;

FIG. 2 is a flow chart of the user portrait based skill package recommendation method according to an embodiment of the present invention; and

FIG. 3 is a structural schematic diagram of the user portrait based skill package recommendation system according to an embodiment of the present invention.

### DETAILED DESCRIPTION OF THE EMBODIMENTS

The technical solution of the present invention will be further described in details in combination with specific embodiments. It is apparent that the described embodiments are only a part of the embodiments of the present invention, but not the whole. Based on the embodiments of the present invention, all the other embodiments obtained by those ordinary skilled in the art without inventive effort are within the scope of the present invention.

The intelligent integration degree of modern society is getting higher and higher, and intelligent robots have entered the daily life of human beings from mysterious laboratories. All kinds of intelligent robots on the market are constantly pursued by fashionable people. Intelligent robot is a machine with human bionics characteristics, and can learn as human does. The more the intelligent robot learns, the more powerful the intelligent robot is, and the more experience the intelligent robot brings to the user. However, the intelligent robot learns by installing skill packages having different functions; and the installation of a skill package enables the intelligent robot to get a corresponding skill. The user is required to participate in the whole learning process of the intelligent robot, and selects and installs a skill package the user prefers, which requires a lot of time. For the user having little spare time, the intelligent robot thereof has few skills, thus bringing a poor use experience to the user.

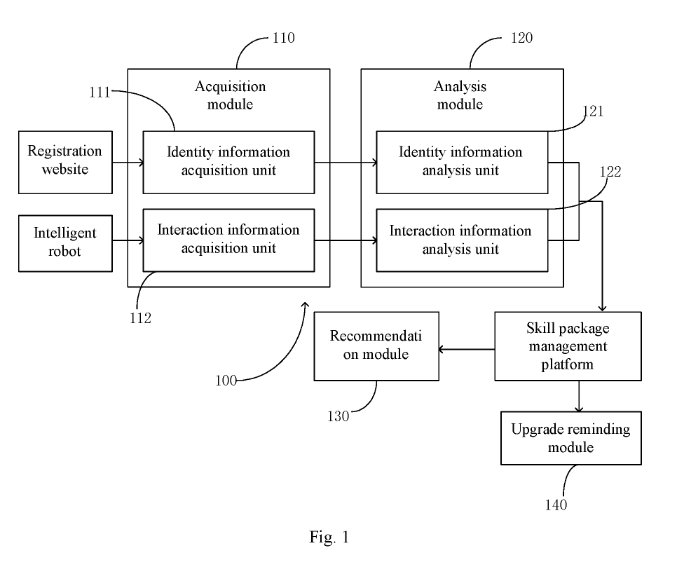

Please refer to FIG. 1 which is a structural schematic diagram of the user portrait based skill package recommendation device according to the present invention. The device 100 comprises an acquisition module 110, an analysis module 120 and a recommendation module 130.

The acquisition module 100 is used for acquiring and collating the identity information of an intelligent robot user and the interaction information of the user and the intelligent robot, and acquiring the user portrait information of the user, wherein the user portrait information at least comprises the identity information of the user, the interaction information of the user and the intelligent robot, and the information pertaining to usage parameters of the user for each skill package of the intelligent robot; and the usage parameters at least comprise the usage frequency, duration and period of the user for each skill package;

The acquisition module 110 comprises: an identity information acquisition unit 111 and an interaction information acquisition unit 112, wherein the identity information acquisition unit 111 is used for connecting an intelligent robot website to acquire the registration information of the user as the identity information of the intelligent robot user; and the interaction information acquisition unit 112 is used for acquiring and identifying the interaction information of the user and the intelligent robot. User portrait, also called as character portrait, is a tagged portrait abstracted from the demographic information, social relationships, preferences, consumer behavior and other information of a user. The core work to construct a user portrait is to tag the user, and the tag is partially directly acquired from the behavior data of the user, partially acquired by digging according to a series of algorithms or rules. The data directly acquired is generally the data that the user actively fills and uploads on a web site or an APP, such as the name, occupation, identity card, student card, driver license, and bank card of the user, as well as the information generated when the user browses and searches for a webpage, on the basis of which the identity type of the user can be determined. For example, the identity type of the user can be determined according to the type of a program the user enjoys, the type of a shop the user browses when shopping, and the professional website the user browses. For a programmer enjoying animation works and headphones, the identity type thereof can be tagged with IT, animation, and headphone. An intelligent robot user often treats the intelligent robot as a friend and chats with the intelligent robot. In the process of chatting, the interaction information acquisition unit 112 acquires a high frequently word which often appears in the interactive chat information. In the present embodiment, a word which appears more than three times is defined as a high frequency word.

The analysis module 120 is connected to a skill package management platform at a cloud network terminal, and is used for analyzing the user portrait information and associating with a first skill package on the skill package management platform according to the user portrait information, wherein the description information of the first skill package comprises the whole or a part of the user portrait information.

The analysis module 120 comprises an identity information analysis unit 121 and an interaction information analysis unit 122, wherein the identity information analysis unit 121 is used for analyzing the identity information of the user, determining the identity type of the user, and associating with the first skill package comprising the identity type of a dominant user in the description information; and the interaction information analysis unit 122 is used for analyzing the interaction information of the user and the intelligent robot, identifying and filtering a high frequency word used in the interaction information, and associating with the first skill package comprising the high frequency word in the function information. In the present embodiment, the analysis module 120 is connected to the skill package management platform, determines the identity type and a high frequency word after the user portrait information is analyzed, and searches on the skill package management platform for a skill package the function information of which comprises the identity type and/or the high frequency word. For example, when a user is determined to be a stay-at-home mom according to the identity type, the analysis module searches on the skill package management platform for a skill package that other stay-at-home mom type intelligent robot users use and give a comparatively high evaluation, or searches for a relevant skill package according to the high frequency word of the user.

The recommendation module 130 is used for acquiring the description information of the first skill package, and pushing the description information to the intelligent robot user, wherein the description information of the first skill package further comprises the identity type of a dominant user of a corresponding skill package, function information and installed internal memory information.

In addition, further comprising an upgrade reminding module 140, used for reminding to upgrade the first skill package after the recommendation module 130 recommends the first skill package and completes installation on the intelligent robot and when an upgraded version of the first skill package is found. The upgrade reminding module 140 determines the high frequency usage time of the first installation package having been installed on the intelligent robot according to the usage parameter information in the user portrait information, and transmits a reminding signal to the user in the high frequency usage time.

The mode for the upgrade reminding module 140 to remind to upgrade comprises: a voice reminder, a mobile terminal reminder and a community webpage reminder, wherein the voice reminder means that the upgrade reminding module transmits upgrade reminding information to the intelligent robot to enable the intelligent robot to remind in a voice broadcasting manner; the skill package management platform reminder means that the upgrade reminding module transmits the upgrade reminding information to an intelligent terminal connected to the intelligent robot to remind in a texting or message pushing manner; and the community webpage reminder means that the upgrade reminding module transmits the upgrade reminding information in an intra-site message manner to a skill package community website registered by the user to remind.

When the upgrade reminding module 140 reminds to upgrade the skill package, the upgrade reminding module 140 generates and transmits a first reminding instruction, a second reminding instruction and a third reminding instruction to the user for the user to select upgrade time. When the user selects the first reminding instruction, the upgrade reminding module 140 transmits the first reminding instruction to the skill package management platform (unshown in the figure), acquires the upgrade installation package of the to-be-upgraded first skill package, and transmits the upgrade installation package to the intelligent robot to perform upgrade; when the user selects the second reminding instruction, the upgrade reminding module 140 determines the low frequency usage time of the to-be-upgraded first skill package according to the usage parameter information contained in the user portrait information, acquires the upgrade installation package of the to-be-upgraded first skill package in the low frequency usage time, and transmits the upgrade installation package to the intelligent robot to perform upgrade; and when the user selects the third reminding instruction, the upgrade reminding module 140 aborts to remind the user to upgrade the to-be-upgraded skill package.

When the user selects the third reminding instruction, the upgrade reminding module 140 generates a first abort reminding instruction and a second abort reminding instruction for the user to select the mode of aborting to upgrade the first skill package. When the user selects the first abort reminding instruction, the user aborts to upgrade the to-be-upgraded first skill package to the current upgraded version; and when the user selects the second abort reminding instruction, the user aborts to upgrade the to-be-upgraded first skill package to the current upgraded version and the new version generated subsequently.

Different from the prior art, the user portrait based skill package recommendation device of the present invention determines the identity type of a user by acquiring and analyzing user portrait information, selects a high frequency word used in the interaction information of the user and an intelligent robot, selects from a skill package management platform a skill package having the same user identity type and a skill package the functional tag of which comprises the high frequency word, and recommends the selected skill packages to the user. The present invention can recommend to a user a popular skill package that the user may feel interested according to the user portrait of the user, thus saving the time of the user for browsing and selecting a skill package, and improving the use experience of the user.

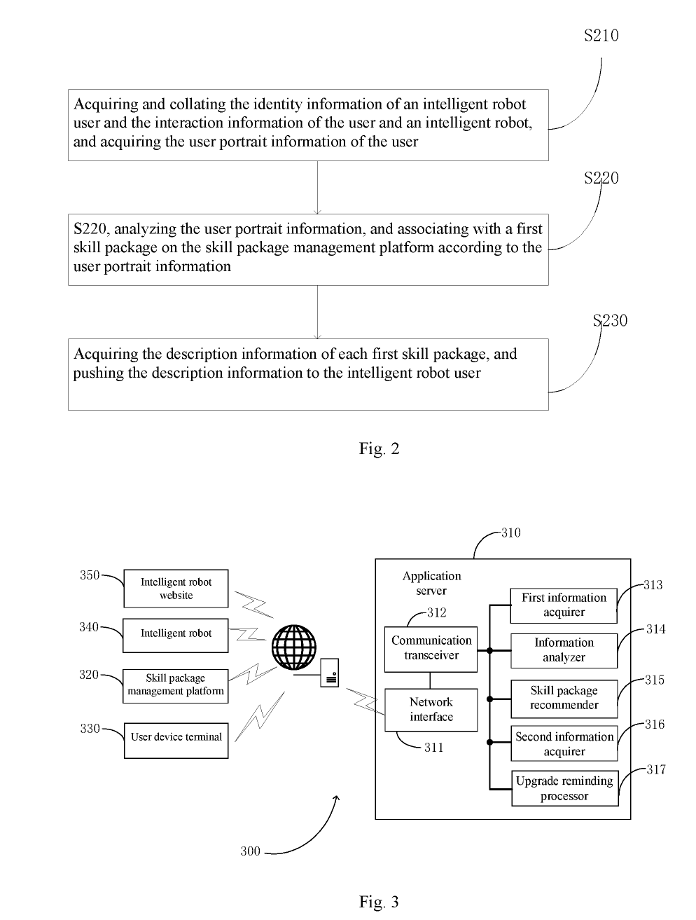

Please refer to FIG. 2 which is a flow chart of the user portrait based skill package recommendation method according to the present invention. The step comprises the steps of:

S210, acquiring and collating the identity information of an intelligent robot user and the interaction information of the user and the intelligent robot, and acquiring the user portrait information of the user, wherein the user portrait information at least comprises the identity information of the user, the interaction information of the user and the intelligent robot, and the information pertaining to usage parameters of the user for each skill package of the intelligent robot; and the usage parameters at least comprise the usage frequency, duration and period of the user for each skill package;

Connecting an intelligent robot website to acquire the registration information of the user as the identity information of the intelligent robot user; and acquiring and identifying the interaction information of the user and the intelligent robot.

S220, analyzing the user portrait information and associating with a first skill package on the skill package management platform according to the user portrait information, wherein the description information of the first skill package comprises the whole or a part of the user portrait information.

Analyzing the identity information of the user, determining the identity type of the user, and associating with the first skill package comprising the identity type of a dominant user in the description information; and analyzing the interaction information of the user and the intelligent robot, identifying and filtering a high frequency word used in the interaction information, and associating with the first skill package comprising the high frequency word in the function information.

S230, acquiring the description information of the first skill package, and pushing the description information to the intelligent robot user, wherein the description information of the first skill package further comprises the identity type of a dominant user of a corresponding skill package, function information and installed internal memory information.

In addition, further comprising the step of: reminding to upgrade the first skill package after the recommendation module recommends the first skill package and completes installation on the intelligent robot and when an upgraded version of the first skill package is found. Determining the high frequency usage time of a first installation package having been installed on the intelligent robot according to the usage parameter information in the user portrait information, and transmitting a reminding signal to the user in the high frequency usage time.

Different from the prior art, the user portrait based skill package recommendation method of the present invention determines the identity type of a user by acquiring and analyzing user portrait information, selects a high frequency word used in the interaction information of the user and an intelligent robot, selects from a skill package management platform a skill package having the same user identity type and a skill package the functional tag of which comprises the high frequency word, and recommends the selected skill packages to the user. The present invention can recommend to a user a popular skill package that the user may feel interested according to the user portrait of the user, thus saving the time of the user for browsing and selecting a skill package, and improving the use experience of the user.

As shown in FIG. 3, on the basis of the skill package recommendation method, the present embodiment provides a user portrait based skill package recommendation system 300, comprising an application server 310, a skill package management platform 320, and a user device terminal 330.

The application server 310 comprises a network interface 311, a communication transceiver 312, a first information acquirer 313, an information analyzer 314, a skill package recommender 315, and a second information acquirer 316. The network interface 311 is connected to the communication transceiver 312; the first information acquirer 313, the information analyzer 314, the skill package recommender 315, the second information acquirer 316, and the communication transceiver 312 are all connected together via a bus; the application server 310 accesses a network via the network interface 311, and interacts data with other devices in the network via the communication transceiver 312.

The first information acquirer 313 generates, according to a communication protocol between an intelligent robot 340 and an intelligent robot website 350, an information invoke request for invoking user portrait information, transmits the information invoke request to the intelligent robot 340 and the intelligent robot website 350 via the communication transceiver 312, and inputs into the information analyzer 314 the user portrait information returned by the intelligent robot 340 and the intelligent robot website 350.

Wherein the user portrait information at least comprises the identity information of the user, the interaction information of the user and the intelligent robot, and the information pertaining to usage parameters of the user for each skill package of the intelligent robot; and the usage parameters at least comprise the usage frequency, duration and period of the user for each skill package;

The intelligent robot 340 comprises a microphone, an analog-to-digital converter, a voice identification processor, an image acquisition device, an image processor, and a memory. The microphone, the analog-to-digital converter and the voice identification processor are sequentially connected; the microphone is used for acquiring a voice signal of the user when the user and a robot are dialoging; the analog-to-digital converter is used for converting the voice signal into voice digital information; the voice identification processor is used for converting the voice digital information into text information, and inputting into the processor; the image acquisition device is used for acquiring an image containing the user; and the image processor is used for identifying image information from the image containing the user, and inputting into the memory, wherein the image information comprises but not limited to the following information: the expression information, environment, and gesture information of the user and the like. The intelligent robot 340 periodically uploads the acquired text information and image information to the intelligent robot website 350, and analyzes the user information of the intelligent robot 340 via a website server to acquire the deep level of user portrait information. The application server 310 can acquire the information of the user from the intelligent robot 340, the intelligent robot website 350 and other places to perfect the user portrait. For example, the application server 310 segments the text information in the interaction information into words, labels a part-of-speech for each word according to the word segmenting result, extracts a key word in the text information according to the labeled part-of-speech, and identifies the intention of the user according to the key word, for example, if the user often chats about delicious food, then the application server 310 can acquire the preference of the user for delicious food, and recommend a relevant skill package. The application server can also combine the expression information of the user to pre-store in the memory a human “expression-mood” corresponding relationship formed according to the research results of psychology and expression science, and acquires the mood of the user when the robot is using a certain skill package by combining the acquired expression information of the user and the “expression-mood” corresponding relationship, so as to acquire the preference degree of the user for the skill package.

The information analyzer 314 is used for analyzing the user portrait information, and transmitting the analysis result to the second information acquirer 316.

The second information acquirer 316 is used for generating a search request via the search interface of the skill package management platform 320 according to the analysis result of the portrait information, and transmitting the search request to the skill package management platform 320 via the communication transceiver 312.

The skill package management platform 320 associates with a first skill package on the skill package management platform 320 according to the user portrait information in the search request, and feeds back all the associated first skill packages to the second information acquirer 316, wherein the description information of the first skill package comprises the whole or a part of the user portrait information; and

[symbol]

The recommendation module 315 is used for acquiring the description information of the first skill package from the second information acquirer 316, and pushing the description information to the user device terminal 330, wherein the description information of the first skill package further comprises the identity type of a dominant user of a corresponding skill package, function information and installed internal memory information.

Preferably, the first information acquirer 313 is specifically used for connecting an intelligent robot website 350 to acquire the registration information of the user as the identity information of the intelligent robot 340 user, and acquiring and identifying the interaction information of the user and the intelligent robot 340.

Preferably, the information analyzer is specifically used for analyzing the identity information of the user, determining the identity type of the user, analyzing the interaction information of the user and the intelligent robot, and identifying and filtering a high frequency word used in the interaction information. In the present embodiment, the information analyzer 120 is connected to the skill package management platform, determines the identity type and a high frequency word after the user portrait information is analyzed, and searches on the skill package management platform for a skill package the function information of which comprises the identity type and/or the high frequency word. For example, when a user is determined to be a stay-at-home mom according to the identity type, the analysis module searches on the skill package management platform for a skill package that other stay-at-home mom type intelligent robot users use and give a comparatively high evaluation, or searches for a relevant skill package according to the high frequency word of the user.

Correspondingly, the skill package management platform 320 is specifically used for associating with the first skill package on the skill package management platform 320 according to the identity type of the user in the search request and the high frequency word used in the communication information, and feeding back all the associated first skill packages to the second information acquirer 316.

Preferably, further comprising an upgrade reminding processor 317, used for: transmitting a message for reminding the user to upgrade the first skill package to the user device terminal 330 after the first skill package is recommended and installed on the intelligent robot 340 and when an upgraded version of the first skill package is found.

Preferably, the upgrade reminding processor 317 is further used for determining the high frequency usage time of the first installation package having been installed on the intelligent robot 340 according to the usage parameter information in the user portrait information, and transmitting a reminding signal to the user in the high frequency usage time.

Alternatively, the first information acquirer 313, the information analyzer 314, the skill package recommender 315, the second information acquirer 316, and the upgrade reminding processor 317 can be a central processing unit (CPU), an application specific integrated circuit (ASIC), a field-programmable gate array (FPGA), or a complex programmable logic device (CPLD).

Once the intelligent robot 340 user completes user registration on the intelligent robot website 350 via a computer or a mobile terminal device, the intelligent robot 340 can be used.

The user portrait based skill package recommendation system 300 periodically acquires and collates the identity information of the intelligent robot user and the interaction of the user and the intelligent robot from the intelligent robot 340 and the intelligent robot website 350 via a network, acquires and analyzes the user portrait information of the user. The system further associates with a first skill package on the skill package management platform 320 according to the user portrait information, acquires the description information of each first skill package, and pushes the description information to the intelligent robot 340 user, such that the user can select to install the first skill package on the intelligent robot 340, thus enabling the intelligent robot 340 to obtain a corresponding skill. In addition, the user portrait based skill package recommendation system 300 can further remind an skill package having been installed on the intelligent robot of an upgraded version and a usage frequency, and remind to upgrade the first skill package after the recommendation module recommends the first skill package and completes installation on the intelligent robot 340 and when an upgraded version of the first skill package is found. Furthermore, the system 300 can determine the high frequency usage time of the first installation package having been installed on the intelligent robot 340 according to the usage parameter information in the user portrait information, and transmit a reminding signal to the user in the high frequency usage time.

The user portrait based skill package recommendation system 300 of the present embodiment determines the identity type of a user by acquiring and analyzing user portrait information, selects a high frequency word used in the interaction information of the user and the intelligent robot 340, selects from a skill package management platform a skill package having the same user identity type and a skill package the functional tag of which comprises the high frequency word, and recommends the selected skill packages to the user. The skill package recommendation system 300 of the present embodiment can recommend to a user a popular skill package that the user may feel interested according to the user portrait of the user, thus saving the time of the user for browsing and selecting a skill package, and improving the use experience of the user.

The above mentioned is only the embodiments of the present invention, which does not limit the patent scope of the present invention, and any equivalent structure or process made by using the specification and the drawings of the present invention or direct or indirect applications in other related technical fields should be contained in the scope of patent protection in a similar way.

What is claimed is:

1. A user portrait based skill package recommendation device, used for recommending an installation skill package to an intelligent robot comprising:
an acquisition module, used for acquiring and collating the identity information of an intelligent robot user and the interaction information of the user and the intelligent robot, and acquiring the user portrait information of the user, wherein the user portrait information at least comprises the identity information of the user, the interaction information of the user and the intelligent robot, and the information pertaining to usage parameters of the user for each skill package of the intelligent robot; wherein the usage parameters at least comprise the usage frequency, duration and period of the user for each skill package;
an analysis module, connected to a skill package management platform at a cloud network terminal, and used for analyzing the user portrait information and associating with a first skill package on the skill package management platform according to the user portrait information, wherein the description information of the first skill package comprises the whole or a part of the user portrait information; and
a recommendation module, used for acquiring the description information of the first skill package, and pushing the description information to the intelligent robot user, wherein the description information of the first skill package further comprises the identity type of a dominant user of a corresponding skill package, function information and installed internal memory information.

2. The user portrait based skill package recommendation device according to claim 1, wherein the acquisition module comprises:
an identity information acquisition unit, used for connecting an intelligent robot website to acquire the registration information of the user as the identity information of the intelligent robot user; and
an interaction information acquisition unit, used for acquiring and identifying the interaction information of the user and the intelligent robot.

3. The user portrait based skill package recommendation device according to claim 1, wherein the analysis module comprises:
an identity information analysis unit, used for analyzing the identity information of the user, determining the identity type of the user, and associating with the first skill package comprising the identity type of a dominant user in the description information; and
an interaction information analysis unit, used for analyzing the interaction information of the user and the intelligent robot, identifying and filtering a high frequency word used in the interaction information, and associating with the first skill package comprising the high frequency word in the function information.

4. The user portrait based skill package recommendation device according to claim 3, further comprising an upgrade reminding module, used for reminding to upgrade the first skill package after the recommendation module recommends the first skill package and completes installation on the intelligent robot and when an upgraded version of the first skill package is found.

5. The user portrait based skill package recommendation device according to claim 4, wherein the upgrade reminding module determines the high frequency usage time of the first installation package having been installed on the intelligent robot according to the usage parameter information in the user portrait information, and transmits a reminding signal to the user in the high frequency usage time.

6. The user portrait based skill package recommendation device according to claim 5, wherein the mode for the upgrade reminding module to remind to upgrade comprises: a voice reminder, a mobile terminal reminder and a community webpage reminder, wherein:
the voice reminder means that the upgrade reminding module transmits upgrade reminding information to the intelligent robot to enable the intelligent robot to remind in a voice broadcasting manner;
the skill package management platform reminder means that the upgrade reminding module transmits the upgrade reminding information to an intelligent terminal connected to the intelligent robot to remind in a texting or message pushing manner; and
the community webpage reminder means that the upgrade reminding module transmits the upgrade reminding information in an intra-site message manner to a skill package community website registered by the user to remind.

7. The user portrait based skill package recommendation device according to claim 6, wherein, when the upgrade reminding module reminds to upgrade the skill package, the upgrade reminding module generates and transmits a first reminding instruction, a second reminding instruction and a third reminding instruction to the user for the user to select upgrade time.

8. The user portrait based skill package recommendation device according to claim 7, wherein, when the user selects the first reminding instruction, the upgrade reminding module transmits the first reminding instruction to the skill package management platform, acquires the upgrade installation package of the to-be-upgraded first skill package, and transmits the upgrade installation package to the intelligent robot to perform upgrade; when the user selects the second reminding instruction, the upgrade reminding module determines the low frequency usage time of the to-be-upgraded first skill package according to the usage parameter information contained in the user portrait information, acquires the upgrade installation package of the to-be-upgraded first skill package in the low frequency usage time, and transmits the upgrade installation package to the intelligent robot to perform upgrade; and when the user selects the third reminding instruction, the upgrade reminding module aborts to remind the user to upgrade the to-be-upgraded skill package.

9. The user portrait based skill package recommendation device according to claim 8, wherein, when the user selects the third reminding instruction, the upgrade reminding module generates a first abort reminding instruction and a second abort reminding instruction for the user to select the mode of aborting to upgrade the first skill package.

10. The user portrait based skill package recommendation device according to claim 9, wherein, when the user selects the first abort reminding instruction, the user aborts to upgrade the to-be-upgraded first skill package to the current upgraded version; and when the user selects the second abort reminding instruction, the user aborts to upgrade the to-be-upgraded first skill package this time, and will determine whether to upgrade next time.

11. A user portrait based skill package recommendation method, used for recommending an installation skill package to an intelligent robot comprising the steps of:
acquiring and collating the identity information of an intelligent robot user and the interaction information of the user and the intelligent robot, and acquiring the user portrait information of the user, wherein the user portrait information at least comprises the identity information of the user, the interaction information of the user and the intelligent robot, and the information pertaining to usage parameters of the user for each skill package of the intelligent robot; and the usage parameters at least comprise the usage frequency, duration and period of the user for each skill package;
analyzing the user portrait information and associating with a first skill package on the skill package management platform according to the user portrait information, wherein the description information of the first skill package comprises the whole or a part of the user portrait information; and
acquiring the description information of the first skill package, and pushing the description information to the intelligent robot user, wherein the description information of the first skill package further comprises the identity type of a dominant user of a corresponding skill package, function information and installed internal memory information.

12. The user portrait based skill package recommendation method according to claim 11, wherein the step of acquiring the user portrait information comprises:
connecting an intelligent robot website to acquire the registration information of the user as the identity information of the intelligent robot user; and
acquiring and identifying the interaction information of the user and the intelligent robot.

13. The user portrait based skill package recommendation method according to claim 11, wherein the step of analyzing the user portrait information comprises:
analyzing the identity information of the user, determining the identity type of the user, and associating with the first skill package comprising the identity type of a dominant user in the description information; and
analyzing the interaction information of the user and the intelligent robot, identifying and filtering a high frequency word used in the interaction information, and associating with the first skill package comprising the high frequency word in the function information.

14. The user portrait based skill package recommendation method according to claim 11, further comprising the step of:
reminding to upgrade the first skill package after the recommendation module recommends the first skill package and completes installation on the intelligent robot and when an upgraded version of the first skill package is found.

15. The user portrait based skill package recommendation method according to claim 14, further comprising the steps of: determining the high frequency usage time of a first installation package having been installed on the intelligent robot according to the usage parameter information in the user portrait information, and transmitting a reminding signal to the user in the high frequency usage time.

16. A user portrait based skill package recommendation system, comprising an application server, a skill package management platform, and a user device terminal, wherein:
the application server comprises a network interface, a communication transceiver, a first information acquirer, an information analyzer, a skill package recommender, and a second information acquirer, wherein the network interface is connected to the communication transceiver; wherein the first information acquirer, the information analyzer, the skill package recommender, the second information acquirer, and the communication transceiver are all connected together via a bus; wherein the application server accesses a network via the network interface, and interacts data with other devices in the network via the communication transceiver;
the first information acquirer generates, according to a communication protocol between an intelligent robot and an intelligent robot website, an information invoke request for invoking user portrait information, transmits the information invoke request to the intelligent robot and the intelligent robot website via the communication transceiver, and inputs into the information analyzer the user portrait information returned by the intelligent robot and the intelligent robot website;
the information analyzer is used for analyzing the user portrait information, and transmitting the analysis result to the second information acquirer;
the second information acquirer is used for generating a search request via the search interface of the skill package management platform according to the analysis result of the portrait information, and transmitting the search request to the skill package management platform via the communication transceiver;
the skill package management platform associates with a first skill package on the skill package management platform according to the user portrait information in the search request, and feeds back all the associated first skill packages to the second information acquirer, wherein the description information of the first skill package comprises the whole or a part of the user portrait information; and
the skill package recommender is used for acquiring the description information of the first skill package from the second information acquirer, and pushing the description information to the user device terminal, wherein the description information of the first skill package further comprises the identity type of a dominant user of a corresponding skill package, function information and installed internal memory information.

17. The system according to claim 16, wherein the first information acquirer is specifically used for:
connecting an intelligent robot website to acquire the registration information of the user as the identity information of the intelligent robot user; and
acquiring and identifying the interaction information of the user and the intelligent robot.

18. The system according to claim 17, wherein the information analyzer is specifically used for:
analyzing the identity information of the user, and determining the identity type of the user; and
analyzing the interaction information of the user and the intelligent robot, identifying and filtering a high frequency word used in the interaction information;
wherein the skill package management platform is specifically used for:
associating with the first skill package on the skill package management platform according to the identity type of the user in the search request and the high frequency word used in the communication information, and feeding back all the associated first skill packages to the second information acquirer.

19. The system according to claim 16, further comprising an upgrade reminding processor, used for:
transmitting a message for reminding the user to upgrade the first skill package to the user device terminal after the first skill package is recommended and installed on the intelligent robot and when an upgraded version of the first skill package is found.

20. The system according to claim 19, wherein the upgrade reminding processor is further used for determining the high frequency usage time of the first installation package having been installed on the intelligent robot according to the usage parameter information in the user portrait information, and transmitting a reminding signal to the user in the high frequency usage time.
